(19) United States
(12) Patent Application Publication
(10) Pub. No.: US 2024/0213780 A1
(43) Pub. Date: Jun. 27, 2024

(54) STORAGE BATTERY CONTROL DEVICE

(71) Applicant: NTT DOCOMO, INC., Chiyoda-ku (JP)

(72) Inventors: Masaki NAKAMURA, Chiyoda-ku (JP); Yuta TOYAMA, Chiyoda-ku (JP); Kazuhiko TAKENO, Chiyoda-ku (JP)

(73) Assignee: NTT DOCOMO, INC., Chiyoda-ku (JP)

(21) Appl. No.: 18/554,669

(22) PCT Filed: Feb. 24, 2022
(86) PCT No.: PCT/JP2022/007695

§ 371 Date: Oct. 10, 2023

(30) Foreign Application Priority Data
May 10, 2021 (JP) 2021-079645

(51) Int. Cl. H02J 3/32; H02J 7/00; H02J 7/04; H02J 13/00

(52) U.S. Cl. CPC H02J 3/32; H02J 7/0013; H02J 7/0048; H02J 7/04; H02J 13/00006

(57) ABSTRACT

A storage battery control device that can perform more flexible control of storage batteries is provided. The storage battery control device 1 includes a control unit 10 configured to perform at least one of first control and second control when it is detected that a charging/discharging criterion for responding to a demand response (DR) request is not satisfied after one or more storage batteries 3 have been determined as a control object of charging/discharging for responding to the DR request, wherein the first control utilizes a storage battery 3 other than the control object, and the second control utilizes a storage battery 3 with a surplus charging/discharging capacity after responding to the DR request out of the storage batteries 3 which are the control object.

### TECHNICAL FIELD

An aspect of the present disclosure relates to a storage battery control device that controls one or more storage batteries.

### BACKGROUND ART

In Patent Literature 1, a power management system including an aggregator system that distributes power-limit shares to a plurality of consumers based on a demand-response request instruction transmitted from an electric power supplier and a consumer power management system that manages electric power of electric devices including storage batteries provided in the consumers based on the power-limit shares distributed by the aggregator system is disclosed.

### CITATION LIST

### Patent Literature

Patent Literature 1: Japanese Unexamined Patent Publication No. 2018-33273

### SUMMARY OF INVENTION

### Technical Problem

The consumer power management system controls storage batteries based on the power-limit shares distributed by the aggregator system. However, for example, it is not considered how to control the storage batteries when some of the storage batteries are out of order. That is, flexible control of the storage batteries cannot be performed.

Therefore, there is demand for more flexible control of storage batteries.

### Solution to Problem

According to an aspect of the present disclosure, there is provided a storage battery control device including a control unit configured to perform at least one of first control and second control when it is detected that a charging/discharging criterion for responding to a demand response (DR) request is not satisfied after one or more storage batteries have been determined as a control object of charging/discharging for responding to the DR request, wherein the first control utilizes a storage battery other than the control object, and the second control utilizes a storage battery with a surplus charging/discharging capacity after responding to the DR request out of the storage batteries which are the control object.

According to this aspect, even when it is detected that the charging/discharging criterion for responding to the DR request is not satisfied, for example, due to failure of some of the storage batteries which are the control object, it is possible to perform at least one of the first control and the second control using the storage batteries. That is, it is possible to perform more flexible control of storage batteries.

### Advantageous Effects of Invention

According to the aspect of the present disclosure, it is possible to perform more flexible control of storage batteries.

### BRIEF DESCRIPTION OF DRAWINGS

FIG. 1 A diagram illustrating an example of a system configuration of a DC power supply system according to the related art.

FIG. 2 A conceptual diagram illustrating a DR request quantity.

FIG. 3 A diagram illustrating an example of a concept that a DR request quantity is covered with control quantities of base stations.

FIG. 4 A diagram illustrating an example of a system configuration of a storage battery control system including a storage battery control device according to an embodiment.

FIG. 5 A diagram illustrating another example of the concept that a DR request quantity is covered with control quantities of base stations.

FIG. 6 A diagram illustrating an example of a functional configuration of the storage battery control device according to the embodiment.

FIG. 7 A diagram illustrating an example of a table of base station selection information.

FIG. 8 A flowchart illustrating an example of a process which is performed by the storage battery control device according to the embodiment.

FIG. 9 A diagram illustrating an example of a hardware configuration of a computer that is used by the storage battery control device according to the embodiment.

### DESCRIPTION OF EMBODIMENTS

Hereinafter, an embodiment of the present disclosure will be described in detail with reference to the accompanying drawings. In description with reference to the drawings, the same elements will be referred to by the same reference signs, and repeated description thereof will be omitted. In the following description, the embodiment of the present disclosure is a specific example of the present invention, and the present invention is not limited to the embodiment unless otherwise mentioned.

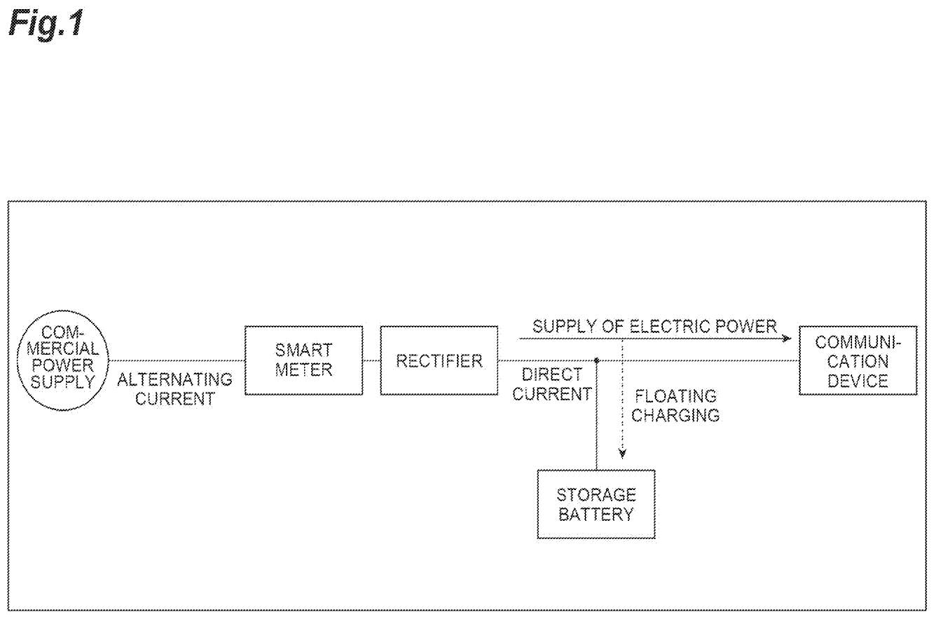

Summary of a DC power supply system of a wireless base station according to the related art will be first described below as the background art. FIG. 1 is a diagram illustrating an example of a system configuration of a DC power supply system according to the related art. As illustrated in FIG. 1, the DC power supply system according to the related art includes a rectifier that converts AC electric power from a commercial power supply (commercial electric power) to DC electric power and outputs the DC electric power, a storage battery, and a communication device (a load) that is supplied with the DC electric power from the rectifier and the storage battery. By setting an output voltage of the rectifier to be higher than a voltage of the storage battery, the communication device can be supplied with electric power while performing charging. By setting the output voltage of the rectifier to be lower than the voltage of the storage battery, electric power can be discharged from the storage battery to the communication device. The DC power supply system may further include a smart meter that is a watt-hour meter that can digitally measure power consumption in the DC power supply system and transmit and receive the measured data or the like to a remote place using a communication function thereof.

On the other hand, with a recent increase of a utilization rate of natural energy in an electric power supplier, power supply/demand adjustment such as demand response (DR) has attracted attention. Since an amount of electric power generated using natural energy such as photovoltaic power generation and wind power generation changes depending on the weather (such as solar radiation and airflow volume), electric power adjustment for flexibly responding to the change is needed, and one measure thereof is DR. In DR, a power consumption reduction request (DR) is issued from an electric power supplier to consumers, an incentive such as a reward is given according to reduced power consumption in the consumers, and a penalty is paid when a request quantity is not covered beyond an error. DR is classified into a “decrease DR” (a power saving request) for decreasing (reducing) consumption and an “increase DR” (a power consumption request) for increasing (creating) consumption.

In Patent Literature 1 described above, a request quantity and a scheduled DR issuance timing for each consumer in a DR request are predicted, and storage battery control for each consumer is performed based on the prediction result. Here, prediction of the scheduled DR issuance timing and the DR request quantity are together referred to as DR actuation prediction. In Patent Literature 1, the DR actuation prediction is performed by logistic regression using parameters highly associated with power consumption such as a predicted power consumption rate presented by an electric power supplier and a wholesale electric power price in a wholesale power exchange.

By controlling the storage batteries in the DC power supply system according to the related art such that an amount of stored electric power is maximized in response to a demand-response request (DR request) received from an electric power supplier, it is possible to maximally reduce electric power for the DR request and to maximize a reward acquired from the electric power supplier.

On the other hand, when DR is performed using a base station group including a plurality of base stations, a backup capacity of a storage battery to be secured for disasters and a load capacity thereof vary depending on base stations, and thus there is a problem in that a duration time and a control quantity at the time of DR actuation vary between the base stations. Accordingly, it is difficult to always deliver a constant control quantity at the time of DR actuation and the base stations need to cooperatively perform discharging such that a DR request quantity and a duration time are satisfied through relay control of the base stations. Since a load of a base station can be considered as being substantially constant, discharging electric power is also substantially constant regardless of time. Therefore, a method of most closely selecting base stations in response to the whole DR request quantity is to solve a rectangular packing problem. Specifically, solutions to a two-dimensional knapsack problem and a strip package problem are known.

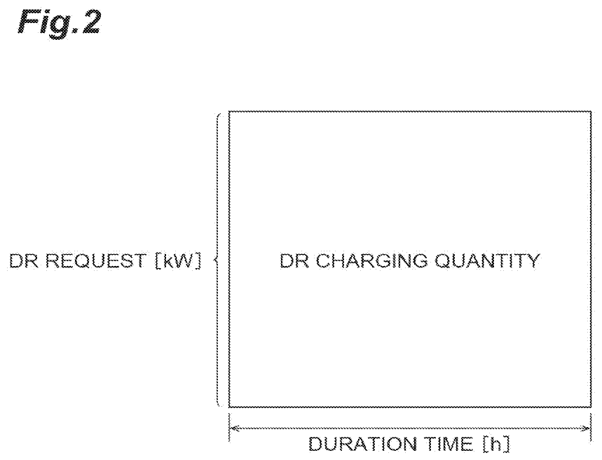

FIG. 2 is a conceptual diagram of a DR request quantity. As illustrated in FIG. 2, the DR request quantity has a concept of a rectangle (including a square, which is the same in the following description) with a DR request (of which the unit is kW) as a longitudinal length and with a duration time (of which the unit is h) as a transverse length.

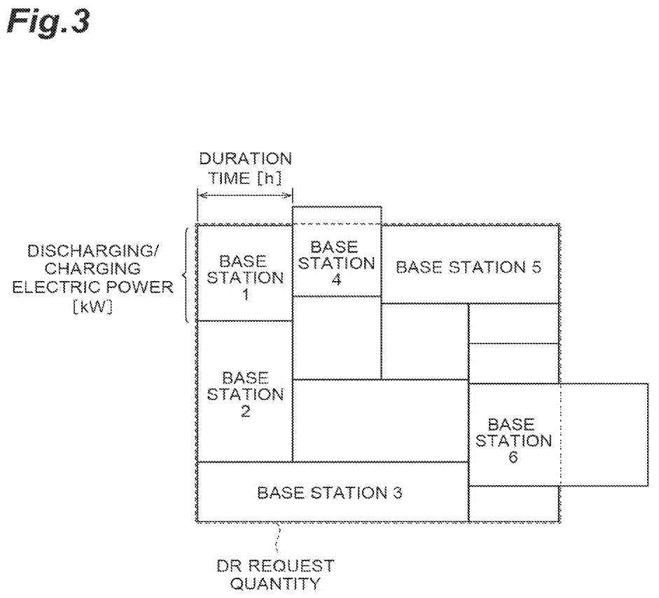

FIG. 3 is a diagram illustrating an example of a conceptual diagram in which a DR request quantity is covered with control quantities of base stations. As illustrated in FIG. 3, the control quantity of each base station has a concept of a rectangle with discharging electric power (in the decrease DR) or charging electric power (in the increase DR) (of which the unit is kW) as a longitudinal length and with a duration time (of which the unit is h) as a transverse length. As illustrated in FIG. 3, an optimal combination of the control quantities of the base stations with which the DR request quantity is covered can be calculated by covering the rectangle of the DR request quantity (illustrated in FIG. 2) with the rectangles of the control quantities of the base stations as compactly as possible.

However, there is a problem in that there is no clear algorithm for correction (of the control quantities of the base stations) when a base station under discharging gets out of order in the DR actuation time or the like.

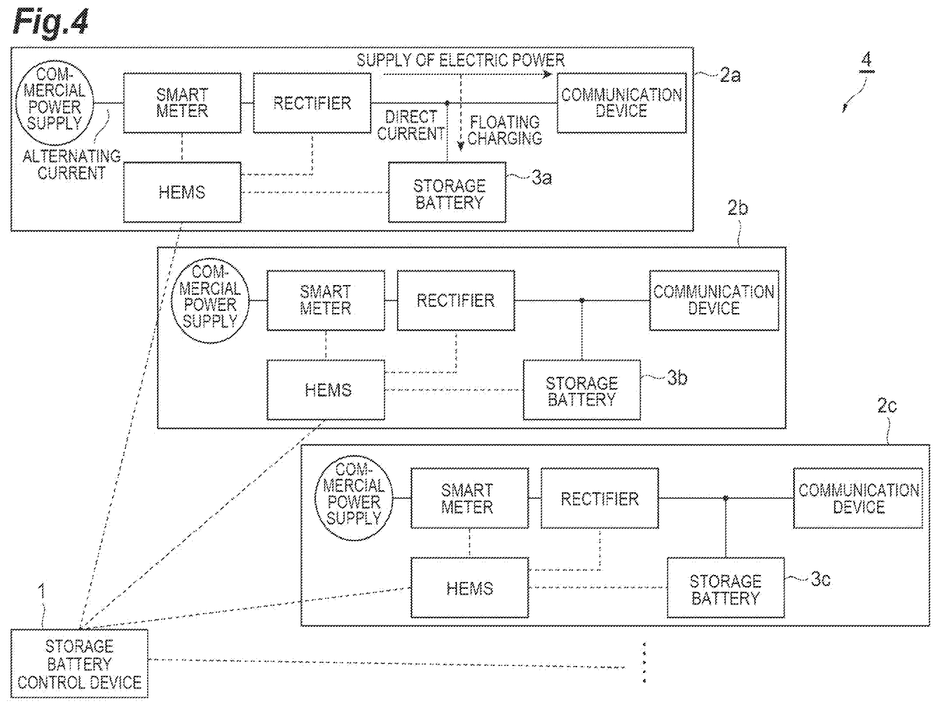

FIG. 4 is a diagram illustrating an example of a system configuration of a storage battery control system 4 according to a storage battery control device 1 according to the embodiment. As illustrated in FIG. 4, the storage battery control system 4 includes a storage battery control device 1 and one or more base stations including a base station 2a, a base station 2b, a base station 2c, . . . (collectively referred to as base stations 2). The storage battery control device 1 and the base stations 2 are communicatively connected to each other via a network such as the Internet or a mobile communication network and can transmit and receive information to and from each other. The base stations 2 are managed by the storage battery control device 1. The base stations 2 are not limited to base stations and may be replaced with arbitrary loads.

The storage battery control device 1 is a server device that controls charging/discharging storage batteries 3 which will be described later in the base stations 2 to respond to a DR request from an electric power supplier or the like. That is, the storage battery control device 1 responds to a DR request by controlling charging/discharging of one or more storage batteries 3. Details of the storage battery control device 1 will be described later.

Each base station 2 has the same configuration as the DC power supply system illustrated in FIG. 1 and includes a home energy management system (HEMS) which is a management system for controlling power consumption in the base station 2. As illustrated in FIG. 4, the base station 2a includes a storage battery 3a, the base station 2b includes a storage battery 3b, the base station 2c includes a storage battery 3c, and these storage batteries are collectively referred to as storage batteries 3 in the following description. When a DR signal is received from the storage battery control device 1 (which will be described later) collecting remote base stations 2 (a base station group) participating in DR, the HEMS of each base station 2 controls an output voltage of the rectifier (sets the voltage to be low in the decrease DR and sets the voltage to be high in the increase DR) and transmits B route data of a smart meter along with rectifier information and storage battery information as a DR result report to the storage battery control device 1.

The configuration of each base station 2 is not limited to the aforementioned description. For example, a base station 2 may include a load and a storage battery 3 charging/discharging the load. In this case, the storage battery control device 1 may (directly) control charging/discharging of the storage battery 3 of each base station 2. In this embodiment, a base station 2 and a storage battery 3 (which is included in the base station 2) may be considered as being the same. For example, processing of the base station 2 may be replaced with processing of the storage battery 3, and processing of the storage battery 3 may be replaced with processing of the base station 2.

The summary of the storage battery control device 1 will be described below.

In order to solve the aforementioned problem, the storage battery control device 1 accurately calculates and corrects charging/discharging electric power and duration times of the base stations 2 in consideration of backup capacities of the storage batteries 3 to be secured. Specifically, the storage battery control device 1 determines the charging/discharging electric power of each base station 2 to be the corresponding value with reference to output electric power of the rectifier of each base station 2 before the DR actuation timing. The storage battery control device 1 calculates the duration time of each base station 2 by dividing a difference obtained by subtracting the backup capacity from the current capacity by the derived charging/discharging electric power. The storage battery control device 1 most closely selects a base station 2 based on the information of each base station 2 acquired as described above and performs relay control of the base stations 2 as illustrated in FIG. 3. However, it is strictly difficult to deliver a constant control quantity as described above. As a result of selection of the base stations 2 in an actual allowable error range (such as +10%), the control quantity is greater than a request quantity as in “base station 4” in FIG. 3 or, for example, the control quantity is less than a request quantity for “base station 5” because “base station 5” is out of order.

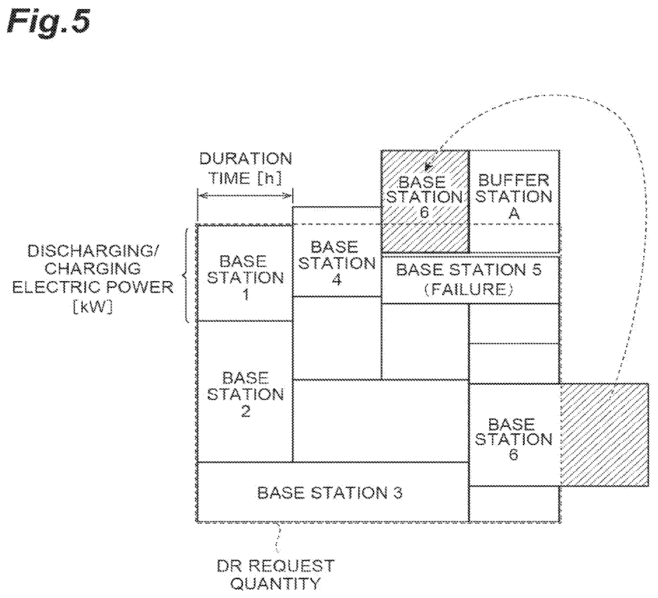

FIG. 5 is a diagram illustrating another example of the concept that a DR request quantity is covered with control quantities of the base stations. In the conceptual diagram illustrated in FIG. 5, “base station 5” is out of order and thus the control quantity is less than a request quantity for “base station 5” in the conceptual diagram illustrated in FIG. 3. The storage battery control device 1 measures a total control quantity (a sum of charging/discharging electric power of the base stations 2 at time t) in real time in preparation of a case in which a base station 2 under charging/discharging gets out of order in this way. When the control quantity is less than the request quantity outside of the error range, the storage battery control device 1 considers that a failure or the like has occurred and performs at least one of two types of control described below such that a difference from the request quantity is covered. The first control is control for performing additional charging/discharging using a base state 2 of which participation in the DR is not scheduled (a buffer station which is “buffer station A” in FIG. 5). The second control is control for performing additional charging/discharging using a base station 2 with a surplus charging/discharging capacity over the duration time (a hatched part of “base station 6” in FIG. 5). Accordingly, the storage battery control device 1 can prepare for an unexpected situation in the DR actuation time.

The summary of the storage battery control device 1 is as described hitherto.

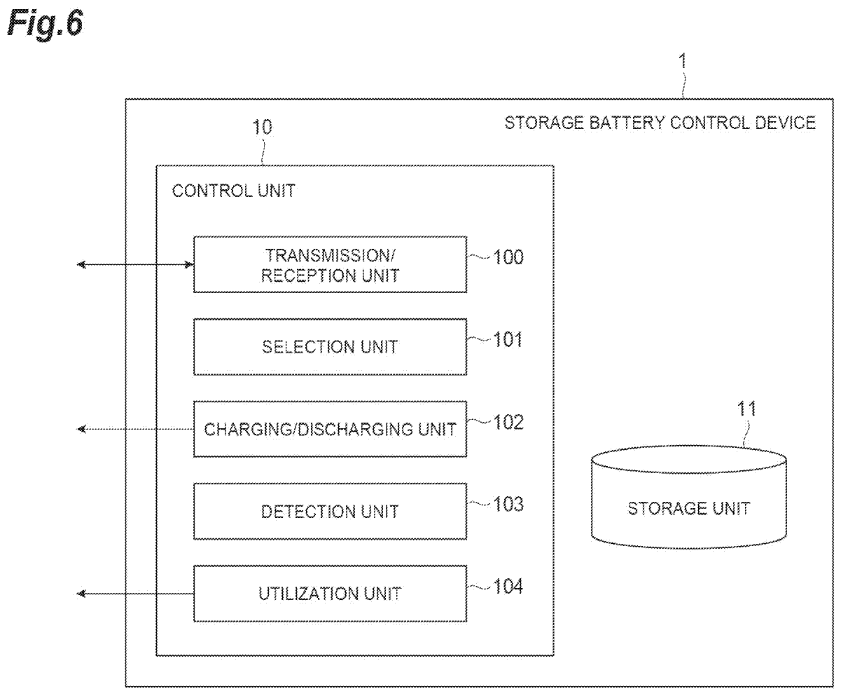

FIG. 6 is a diagram illustrating an example of a functional configuration of the storage battery control device 1. As illustrated in FIG. 6, the storage battery control device 1 includes a control unit 10 (control unit) and a storage unit 11. The control unit 10 includes a transmission/reception unit 100, a selection unit 101, a charging/discharging unit 102, a detection unit 103, and a utilization unit 104. In the embodiment, the transmission/reception unit 100, the selection unit 101, the charging/discharging unit 102, the detection unit 103, and the utilization unit 104 can be appropriately replaced with the “control unit 10.”

The functional blocks of the storage battery control device 1 are assumed to function in the storage battery control device 1, but the present disclosure is not limited thereto. For example, some functional blocks of the storage battery control device 1 may operate in a computer device (including a base station 2) different from the storage battery control device 1 and connected to the storage battery control device 1 via a network while appropriately transmitting/receiving information to and from the storage battery control device 1. Some functional blocks of the storage battery control device 1 may be skipped, a plurality of functional blocks may be incorporated into a single functional block, or a single functional block may be divided into a plurality of functional blocks.

The functions of the storage battery control device 1 illustrated in FIG. 6 will be described below.

The control unit 10 controls charging/discharging of storage batteries 3 of one or more base stations 2 which are managed by the storage battery control device 1 in order to respond to a DR request. Some or all processes which are performed by the control unit 10 may be performed by the transmission/reception unit 100, the selection unit 101, the charging/discharging unit 102, the detection unit 103, or the utilization unit 104 which are included in the control unit 10.

The storage unit 11 stores arbitrary information used for calculation or the like in the storage battery control device 1, results of the calculation in the storage battery control device 1, and the like. Information stored in the storage unit 11 may be appropriately referred to by the functions of the storage battery control device 1.

The transmission/reception unit 100 receives a DR request from an electric power supplier or the like. The transmission/reception unit 100 transmits B-route data of a smart meter or the like required for a DR result report to the electric power supplier or the like. The transmission/reception unit 100 outputs the received DR request to the selection unit 101.

When the DR request is input from the selection unit 101, the selection unit 101 selects (determines) one or more storage batteries as a control object for responding to the DR request out of the base stations 2 managed thereby.

For example, when the DR request is a decrease DR such as “3 hour-100 kW power saving request after 3 hours,” first, the selection unit 101 acquires discharging electric power P from (the rectifier of) one base station 2 managed by the storage battery control device 1. Then, the selection unit 101 acquires a current capacity W from (the storage battery 3 of) the base station 2. Then, the selection unit 101 acquires a backup capacity W_{BU} of the storage battery for disasters to be secured by the base station 2, which is stored in the storage unit 11. The acquisition order of the discharging electric power P, the current capacity W, and the backup capacity W_{BU} is not limited to the aforementioned order and may be arbitrary. Then, the selection unit 101 calculates a duration time T using an expression “T-(W−W_{BU})/P.” Acquisition and calculation are performed on one base station 2 as described above, and the selection unit 101 performs the same acquisition and calculation on all the base stations 2 managed by the storage battery control device 1. Then, the selection unit 101 performs selection of a base station 2 such that a request quantity of the DR request is covered based on the discharging electric power P and the duration time T of each base station 2. This selection is performed, for example, using the method described above with reference to the conceptual diagram illustrated in FIG. 3.

On the other hand, for example, when the DR request is an increase DR, first, the selection unit 101 acquires charging electric power P and a full charging capacity W_{FULL} of the storage battery 3 of one base station 2 managed by the storage battery control device 1, which are stored in the storage unit 11. Then, the selection unit 101 acquires a current capacity W from (the storage battery 3 of) the base station 2. The acquisition order of the charging electric power P, the full charging capacity W_{FULL}, and the current capacity W is not limited to the aforementioned order and may be arbitrary. Then, the selection unit 101 calculates a duration time T using an expression “T-(W_{FULL}− W)/P.” Acquisition and calculation are performed on one base station 2 as described above, and the selection unit 101 performs the same acquisition and calculation on all the base stations 2 managed by the storage battery control device 1. Then, the selection unit 101 performs selection of a base station 2 such that a request quantity of the DR request is covered based on the charging electric power P and the duration time T of each base station 2. This selection is performed, for example, using the method described above with reference to the conceptual diagram illustrated in FIG. 3.

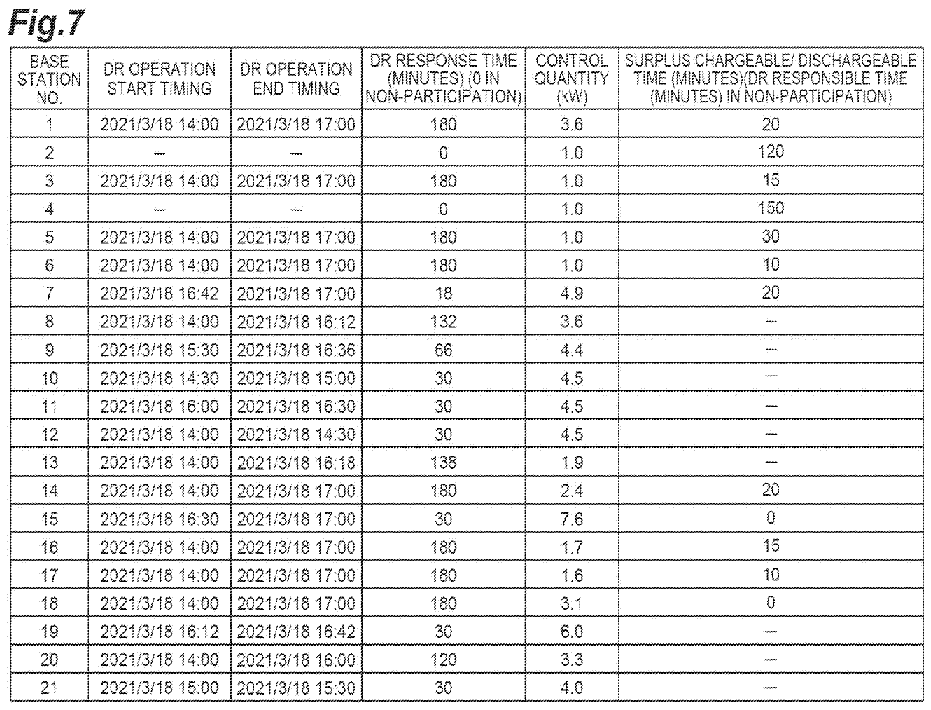

The selection unit 101 generates base station selection information when selection of a base station 2 has been performed and stores the base station selection information in the storage unit 11. FIG. 7 is a diagram illustrating a table example of base station selection information. The table example is an example in which it is assumed that a DR has been actuated in a period from 14:00 to 17:00, Mar. 18, 2021. As illustrated in FIG. 7, the base station selection information is information in which “base station No.” which is identification information of a base station 2, “DR operation start timing” which is a time at which charging/discharging the corresponding base station 2 starts to respond to a DR request, “DR operation end timing” which is a time at which the corresponding charging/discharging ends, “DR response time” (of which the unit is minutes and which is “0” when the corresponding base station does not respond to the DR request (does not participate in the DR)) which is a time in which the corresponding charging/discharging is performed (the corresponding base station 2 responds to the DR request), “control quantity” (of which the unit is kW) which is a quantity of the charging/discharging, and “surplus chargeable/dischargeable time” (of which the unit is minutes and which is a DR responsible time (of which the unit is minutes) when the corresponding base station does not respond to the DR request (does not participate in the DR) which is a time in which the corresponding base station is chargeable/dischargeable over the DR response time (the duration time)) are correlated.

For example, “base station No.” is acquired when the storage battery control device 1 acquires various types of information from the base stations 2 or “base station No.” stored in advance in the storage unit 11 is acquired. The remaining “DR operation start timing,” “DR operation end timing,” “DR response time,” “control quantity,” and “surplus chargeable/dischargeable time” are calculated, for example, based on at least one of information of the DR request, the control quantity, and the discharging electric power P, the charging electric power P, the current capacity W, the backup capacity W_{BU}, the full charging capacity W_{FULL}, and the duration time T of each base station 2.

The charging/discharging unit 102 controls charging/discharging of the storage batteries 3 of the base stations 2 managed by the storage battery control device 1 based on the base station selection information stored in the storage unit 11 (generated by the selection unit 101). More specifically, the charging/discharging unit 102 transmits a charging/discharging instruction based on the base station selection information to the base stations 2 managed by the storage battery control device 1. At a predetermined timing, each base station 2 performs charging/discharging the storage battery 3 based on the received instruction. The charging/discharging is performed, for example, by setting a rectifier voltage V_{RF} (for example, 52 V) to be higher than a storage battery voltage V_{LIB} (For example, 48 V) at the time of charging and setting the rectifier voltage V_{RF} (for example, 45 V) to be lower than the storage battery voltage V_{LIB} (for example, 48 V) at the time of discharging. The electric power flow of the rectifier and the storage battery is determined by, for example, current control as well as voltage control.

The detection unit 103 detects whether a charging/discharging criterion for responding to a demand response (DR) request is satisfied (at an arbitrary timing) after one or more storage batteries 3 have been determined (selected) as a control object of charging/discharging for responding to the DR request. Whether a criterion is satisfied is, for example, whether charging/discharging for responding to the DR request can be performed in the DR response time, that is, whether the DR request is responded to in the DR response time. For example, the detection unit 103 detects whether a control quantity x which is total discharging electric power (in the decrease DR) or charging electric power (in the increase DR) at time t is less than a request quantity A in consideration of an allowable error (a predetermined value). In this case, the criterion is not satisfied when the control quantity is less than the request quantity, and the criterion is satisfied when the control quantity is not less than the request quantity. The detection unit 103 outputs the detection result to the utilization unit 104.

When the detection unit 103 detects that the criterion is not satisfied, the selection unit 101 may generate (update) the base station selection information again.

When the detection result input from the detection unit 103 indicates that the criterion is not satisfied (it is detected that the criterion is not satisfied), the utilization unit 104 performs at least one of first control for utilizing a storage battery 3 which is not a control object and second control for utilizing a storage battery 3 (a surplus charging/discharging station group) with a surplus charging/discharging capacity even after it has responded to the DR request out of the storage batteries 3 which are the control object. More specifically, the utilization unit 104 performs only the first control, performs only the second control, or both the first control and the second control. The second control may utilize a storage battery 3 with a surplus charging/discharging capacity even after it has responded to the DR request out of the storage batteries 3 which are the control object in a period in which utilization of the corresponding storage battery 3 is not scheduled in a period in which the DR request is responded to.

The first control will be more specifically described below. The first control utilizes one or more base stations 2 (base station group/buffer station/buffer station group) of which participation in the DR is not scheduled (the storage batteries 3 of the base stations 2 are charged/discharged). The first control may select and use one or more base stations 2 capable of covering the request quantity of the DR request out of the one or more base stations 2 of which participation in the DR is not scheduled. The one or more base stations 2 of which participation in the DR is not scheduled are, for example, base stations 2 of which the value of the entry “DR response time” in the table example of the base station selection information illustrated in FIG. 7 is “0.” Determination of whether “the request quantity of the DR request can be covered” can be performed, for example, based on the information of the table example. That is, the utilization unit 104 may perform the first control based on the base station selection information stored in the storage unit 11.

The second control will be more specifically described below.

In the decrease DR, first, the utilization unit 104 detects, for example, a base station 2 with a surplus discharging capacity over the duration time (a surplus discharging station group) (for example, a base station 2 of which a value of the entry “surplus chargeable/dischargeable time” in the table example of the base station selection information illustrated in FIG. 7 is greater than “0”) out of the base stations 2 of which participation in the DR is scheduled (which are the control object) such as “base station 6” illustrated in FIG. 3. Then, the utilization unit 104 extracts a base station 2 of which discharging is not scheduled at time t out of the surplus discharging station group with reference to the base station selection information stored in the storage unit 11. Then, the utilization unit 104 discharges the storage battery 3 of the corresponding base station 2 using the extracted base station 2 (performs the second control) such that a difference from the request quantity of the DR request is covered.

In the increase DR, first, the utilization unit 104 detects a base station 2 with a surplus charging capacity over the duration time (a surplus charging station group) (for example, a base station 2 of which a value of the entry “surplus chargeable/dischargeable time” in the table example of the base station selection information illustrated in FIG. 7 is greater than “0”) out of the base stations 2 of which participation in the DR is scheduled (which are the control object). Then, the utilization unit 104 extracts a base station 2 of which charging is not scheduled at time t out of the surplus charging station group with reference to the base station selection information stored in the storage unit 11. Then, the utilization unit 104 charges the storage battery 3 of the corresponding base station 2 using the extracted base station 2 (performs the second control) such that a difference from the request quantity of the DR request is covered.

Variations of the process of the utilization unit 104 will be described below.

The utilization unit 104 may select a storage battery 3 with which the whole storage batteries 3 responding to the DR request satisfy the criterion through at least one of the first control and the second control and utilize the selected storage battery 3. Selection of a storage battery 3 with which the whole storage batteries 3 responding to the DR request satisfy the criterion is performed based on the base station selection information stored in the storage unit 11.

The utilization unit 104 may perform the second control with higher priority than the first control. The utilization unit 104 may determine whether the criterion is satisfied through the second control and perform control based on the determination result. The utilization unit 104 may perform the second control when it is determined that the criterion is satisfied or perform the first control and the second control or perform the first control when it is determined that the criterion is not satisfied.

For example, when there is no surplus discharging station group dischargeable at time t or no surplus charging station group chargeable at time t in the decrease DR or the increase DR or when a difference from the request quantity of the DR request cannot be covered with the surplus discharging station group or the surplus charging station group, the utilization unit 104 additionally discharges or charges a buffer station (for example, the base stations 2 with the base station Nos. “2” and “4” in the table example of the base station selection information illustrated in FIG. 7) with reference to the base station selection information stored in the storage unit 11.

The utilization unit 104 may perform the first control with higher priority than the second control. The utilization unit 104 may determine whether the criterion is satisfied through the first control and perform control based on the determination result. The utilization unit 104 may perform the first control when it is determined that the criterion is satisfied or perform the first control and the second control or perform the second control when it is determined that the criterion is not satisfied.

The utilization unit 104 may perform the aforementioned determination (whether the criterion is satisfied through the first control and whether the criterion is satisfied through the second control) based on charging/discharging schedules of the storage batteries 3 (the base station selection information stored in the storage unit 11).

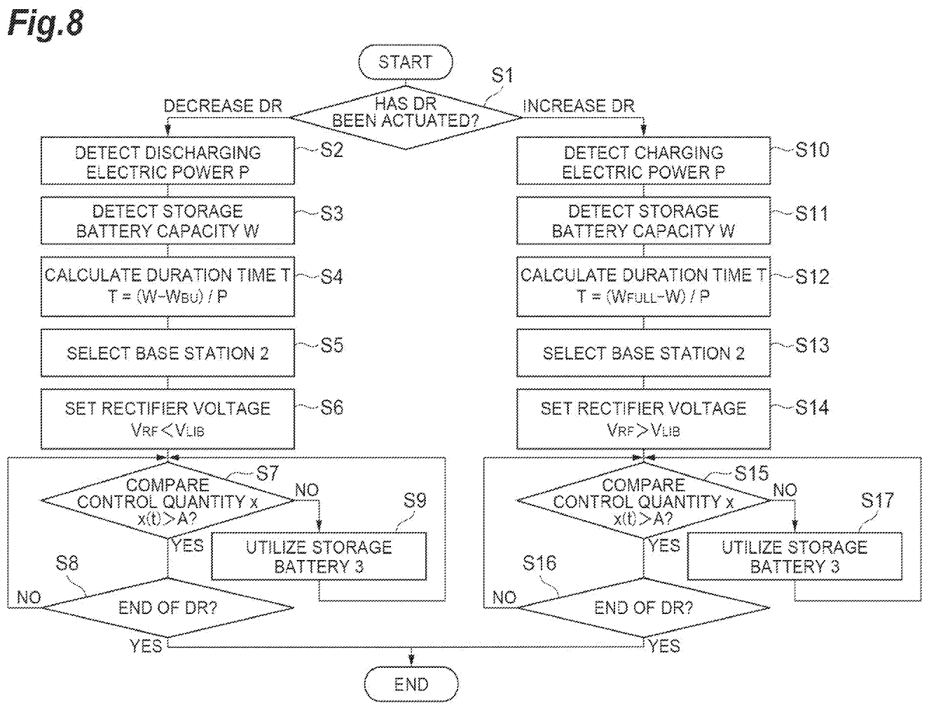

An example of a routine (a storage battery control method) which is performed by the storage battery control device 1 will be described below with reference to FIG. 8. FIG. 8 is a flowchart illustrating an example of the routine which is performed by the storage battery control device 1 according to the embodiment.

First, the transmission/reception unit 100 receives a DR request. When the DR request indicates actuation of a decrease DR (Step S1: decrease DR), the selection unit 101 detects discharging electric power P (Step S2), detects a storage battery capacity W (Step S3), calculates a duration time T (Step S4), and selects a base station 2 (Step S5). The order of Steps S2 and S3 may be inverted. Subsequently to Step S5, the charging/discharging unit 102 controls discharging of the base station 2 selected in Step S5 (Step S6). Then, the detection unit 103 detects whether a discharging criterion for responding to the DR request is satisfied by comparison with a control quantity (Step S7). When it is detected in Step S7 that the criterion is satisfied (Step S7: YES), the control unit 10 determines whether the DR is to end (Step S8). The routine returns to Step S7 when it is determined in Step S8 that the DR is not to end (Step S8: NO), and the routine ends when it is determined in Step S8 that the DR is to end (Step S8: YES). On the other hand, when it is detected in Step S7 that the criterion is not satisfied (Step S7: NO), the utilization unit 104 performs at least one of the first control and the second control using the storage batteries 3 (Step S9), and the routine returns to Step S7.

On the other hand, when the DR request indicates actuation of an increase DR (Step S1: increase DR), the selection unit 101 detects charging electric power P (Step S10), detects a storage battery capacity W (Step S11), calculates a duration time T (Step S12), and selects a base station 2 (Step S13). The order of Steps S10 and S11 may be inverted. Subsequently to Step S12, the charging/discharging unit 102 controls charging of the base station 2 selected in Step S12 (Step S14). Then, the detection unit 103 detects whether a discharging criterion for responding to the DR request is satisfied by comparison with a control quantity (Step S15). When it is detected in Step S15 that the criterion is satisfied (Step S15: YES), the control unit 10 determines whether the DR is to end (Step S16). The routine returns to Step S15 when it is determined in Step S16 that the DR is not to end (Step S16: NO), and the routine ends when it is determined in Step S16 that the DR is to end (Step S16: YES). On the other hand, when it is detected in Step S15 that the criterion is not satisfied (Step S15: NO), the utilization unit 104 performs at least one of the first control and the second control using the storage batteries 3 (Step S17), and the routine returns to Step S15.

Operations and advantages of the storage battery control device 1 according to the embodiment will be described below.

In the storage battery control device 1, when it is detected that a charging/discharging criterion for responding to a demand response (DR) request is not satisfied (this detection may be performed by the detection unit 103, by the control unit 10, or by a device other than the storage battery control device 1 (in this case, the storage battery control device 1 or the control unit 10 receives a notification indicating the detection result from the device)) after one or more storage batteries 3 have been determined as a control object of charging/discharging for responding to the DR request (this determination may be performed by the selection unit 101, by the control unit 10, or by a device other than the storage battery control device 1 (in this case, the storage battery control device 1 or the control unit 10 receives a notification indicating the determination result from the device)), the control unit 10 performs at least one of the first control utilizing a storage battery 3 which is not the control object and the second control utilizing a storage battery 3 with a surplus charging/discharging capacity even after it has responded to the DR request out of the storage batteries 3 which are the control object. With this configuration, even when it is detected that the charging/discharging criterion for responding to the DR request is not satisfied, for example, due to failure of some of the storage batteries 3 which are the control object, it is possible to perform at least one of the first control and the second control utilizing the storage batteries. That is, it is possible to perform more flexible control of storage batteries 3.

In the storage battery control device 1, the second control may utilize a storage battery 3 with a surplus charging/discharging capacity after responding to the DR request out of the storage batteries 3 which are the control object in a period in which utilization of the storage battery 3 is not scheduled in a period in which the DR request is responded to. With this configuration, since the period in which the DR request is responded to can be utilized without any overlap, it is possible to more reliably control the storage batteries 3.

In the storage battery control device 1, the control unit 10 may perform the second control with higher priority to the first control. With this configuration, it is possible to decrease the number of base stations 2 participating in the DR, which is preferable in view of countermeasures against disasters. It is possible to effectively utilizing surplus charging/discharging.

In the storage battery control device 1, the control unit 10 may determine whether the criterion is satisfied through the second control and perform control based on a result of determination. With this configuration, since it is determined in advance whether the criterion is satisfied, it is possible to more reliably control the storage batteries 3.

In the storage battery control device 1, the control unit 10 may perform the second control when it is determined that the criterion is satisfied, or the control unit 10 may perform the first control and the second control or perform the first control when it is determined that the criterion is not satisfied. With this configuration, it is possible to perform control more reliably satisfying the criterion.

In the storage battery control device 1, the control unit 10 may perform the first control with higher priority to the second control. With this configuration, it is possible to effectively utilizing a base station 2 not participating in the DR. Since more base stations 2 can be operated, it is possible to perform load distribution.

In the storage battery control device 1, the control unit 10 may determine whether the criterion is satisfied through the first control and perform control based on a result of determination. With this configuration, since it is determined in advance whether the criterion is satisfied, it is possible to more reliably control the storage batteries 3.

In the storage battery control device 1, the control unit 10 may perform the first control when it is determined that the criterion is satisfied, or the control unit 10 may perform the first control and the second control or perform the second control when it is determined that the criterion is not satisfied. With this configuration, it is possible to perform control more reliably satisfying the criterion.

In the storage battery control device 1, the control unit 10 may perform the determination based on a charging/discharging schedule of the storage batteries 3. With this configuration, it is possible to perform more accurate determination.

In the storage battery control device 1, the control unit 10 may select a storage battery 3 satisfying the criterion out of all the storage batteries 3 responding to the DR request through at least one of the first control and the second control and utilize the selected storage battery 3. With this configuration, it is possible to perform control more reliably satisfying the criterion.

With the storage battery control device 1, even when the device has a problem in the DR actuation time, it is possible to minimize penalties by covering the DR request quantity through correction control in consideration of securement of a backup capacity for disasters in DR control utilizing a group of base stations 2. It is possible to effectively utilize power storage resources through correction control in which discrete discharging of specific base stations 2 has priority, which causes maximization of a reward. With the storage battery control device 1, it is possible to perform DR control utilizing a group of base stations 2. With the storage battery control device 1, when a control quantity is less than a request quantity in the DR actuation time, it is possible to perform correction using a buffer station group. With the storage battery control device 1, by performing additional discharging using a base station 2 with a surplus charging/discharging capacity over the duration time out of the base stations which are scheduled to participate in the DR, it is possible to effectively utilize power storage resources without useless discharging over the duration time of the request. The storage battery control device 1 can realize electric power demand/supply adjustment while securing supply of electric power to radio equipment in emergency through control of the storage batteries of the radio base stations 2. With the storage battery control device 1, it is possible to respond to a demand response while securing supply of electric power to radio equipment in emergency through discrete charging/discharging control of specific base stations 2.

The storage battery control device 1 is applicable to the field of DC power control technology in a radio base station.

Examples of the storage battery control device 1 and the storage battery control method include a DC power supply system (including a rectifier and a storage battery) or a power control method (a demand-response control method) described below.

### [Article 1]

A DC power supply system including a rectifier and a storage battery or a power control method thereof, wherein the DC power supply system further includes a control unit configured to monitor or control the rectifier and the storage battery for each station and responds to a demand response by cooperatively charging/discharging the storage batteries of a plurality of base stations.

### [Article 2]

The DC power supply system according to Article 1 or the power control method thereof, wherein a charging/discharging quantity of the storage battery is adjusted by adjusting an output voltage of the rectifier.

### [Article 3]

The DC power supply system according to Article 1 or the power control method thereof, wherein a backup capacity for disasters is secured by calculating a responsible quantity to the demand response based on rectifier information and storage battery information for each base station.

### [Article 4]

The DC power supply system according to Article 1 or the power control method thereof, wherein correction is performed by comparing a control quantity of all the base stations and a request quantity in a demand-response actuation time and additionally charging/discharging a base station which is not scheduled to participate in the demand response when the request quantity is not covered with the control quantity.

### [Article 5]

A DC power supply system including a rectifier and a storage battery or a power control method thereof, wherein the DC power supply system further includes a control unit configured to monitor or control the rectifier and the storage battery for each station, responds to a demand response by cooperatively charging/discharging the storage batteries of a plurality of base stations, and utilizes a base station of which surplus charging/discharging is assumed to be performed over an actuation time in another actuation time period.

### [Article 6]

The DC power supply system according to Article 5 or the power control method thereof, wherein a charging/discharging quantity of the storage battery is adjusted by adjusting an output voltage of the rectifier.

### [Article 7]

The DC power supply system according to Article 5 or the power control method thereof, wherein a backup capacity for disasters is secured by calculating a responsible quantity to the demand response based on rectifier information and storage battery information for each base station.

### [Article 8]

The DC power supply system according to Article 5 or the power control method thereof, wherein correction is performed by comparing a control quantity of all the base stations and a request quantity in a demand-response actuation time and utilizing a base station of which surplus charging/discharging is assumed to be performed with higher priority than a base station which is not scheduled to participate in the demand response when the request quantity is not covered with the control quantity.

### [Article 9]

The DC power supply system according to Article 5 or the power control method thereof, wherein a base station of which surplus charging/discharging is assumed to be performed over an actuation time is determined to be utilized when a request quantity is not covered with a control quantity with reference to a charging/discharging schedule of the base station.

The block diagrams used to describe the aforementioned embodiment show blocks of functional units. These functional blocks (constituent units) are realized by an arbitrary combination of at least one of hardware and software. The realization method of each functional block is not particularly limited. That is, each functional block may be realized by a single device which is physically or logically coupled, or may be realized by two or more devices which are physically or logically separated and which are directly or indirectly connected (for example, in a wired or wireless manner). Each functional block may be realized by combining software with the single device or the two or more devices.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (a constituent unit) for transmitting is referred to as a transmitting unit or a transmitter. As described above, the realization method of each function is not particularly limited.

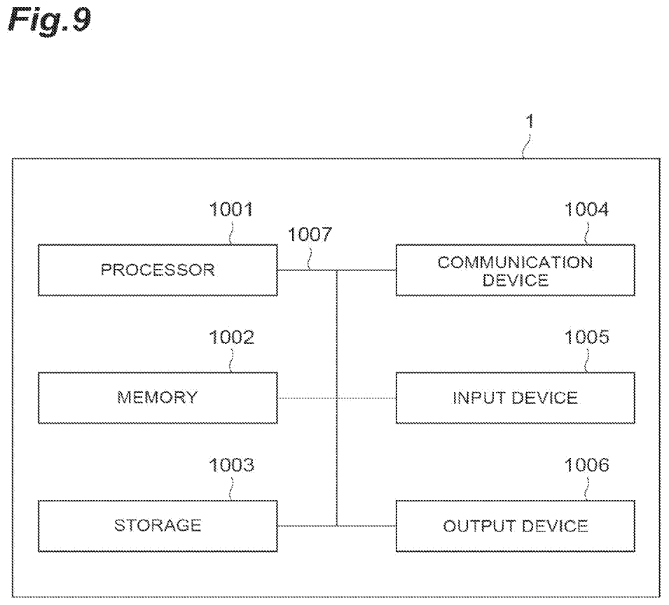

For example, the storage battery control device 1 according to an embodiment of the present disclosure may serve as a computer that performs the process steps of the storage battery control method according to the present disclosure. FIG. 9 is a diagram illustrating an example of a hardware configuration of the storage battery control device 1 according to an embodiment of the present disclosure. The storage battery control device 1 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the storage battery control device 1 may be configured to include one or more devices illustrated in the drawing or may be configured to exclude some devices thereof.

The functions of the storage battery control device 1 can be realized by reading predetermined software (program) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the control unit 10, the transmission/reception unit 100, the selection unit 101, the charging/discharging unit 102, the detection unit 103, and the utilization unit 104 may be realized by the processor 1001.

The processor 1001 reads a program (a program code), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used. For example, the control unit 10, the transmission/reception unit 100, the selection unit 101, the charging/discharging unit 102, the detection unit 103, and the utilization unit 104 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform a radio communication method according to an embodiment of the present disclosure.

The storage 1003 is a computer-readable storage medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including at least one of the memory 1002 and the storage 1003.

The communication device 1004 is hardware (a transmitting and receiving device) that performs communication between computers via at least one of a wired network and a wireless network and is also referred to as, for example, a network device, a network controller, a network card, or a communication module. The communication device 1004 may include, for example, a radio-frequency switch, a duplexer, a filter, and a frequency synthesizer to realize at least one of frequency division duplex (FDD) and time division duplex (TDD). For example, the control unit 10, the transmission/reception unit 100, the selection unit 101, the charging/discharging unit 102, the detection unit 103, and the utilization unit 104 may be realized by the communication device 1004. The transmission/reception unit 100 may be physically or logically separated and mounted as a transmitting unit 100a and a receiving unit 100b.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The storage battery control device 1 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted using at least one piece of the hardware.

Notifying of information is not limited to the aspects/embodiments described in the present disclosure, and may be performed using another method.

The order of processing steps, the sequences, the flowcharts, and the like of the aspects/embodiments described above in the present disclosure may be changed unless conflictions arise. For example, in the methods described in the present disclosure, various steps are described as elements in the exemplary order, and the methods are not limited to the described specific order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison between numerical values (for example, comparison with a predetermined value).

The aspects/embodiments described in the present disclosure may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent to those skilled in the art that the present disclosure is not limited to the embodiments described in the present disclosure. The present disclosure can be altered and modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, commands, information, and the like may be transmitted and received via a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), the at least one of wired technology and wireless technology is included in definition of the transmission medium.

Information, signals, and the like described in the present disclosure may be expressed using one of various different techniques. For example, data, instructions, commands, information, signals, bits, symbols, and chips which can be mentioned in the overall description may be expressed by a voltage, a current, electromagnetic waves, a magnetic field or magnetic particles, a photo field or photons, or an arbitrary combination thereof.

Terms described in the present disclosure and terms required for understanding the present disclosure may be substituted with terms having the same or similar meanings.

The terms “system” and “network” used in the present disclosure are compatibly used.

Information, parameters, and the like described above in the present disclosure may be expressed using absolute values, may be expressed using values relative to predetermined values, or may be expressed using other corresponding information. For example, radio resources may be indicated by indices.

Names used for the aforementioned parameters are not restrictive in any respect. Mathematical expressions or the like using the parameters may be different from those which are explicitly described in the present disclosure. Since various information elements can be identified by all appropriate names, various names assigned to the various information elements are not restricted in any respect.

In the present disclosure, terms such as “base station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” and “component carrier” can be compatibly used. A base station may be referred to as a term such as a macro cell, a small cell, a femtocell, or a picocell.

The term “determining” or “determination” used in the present disclosure may include various types of operations. The term “determining” or “determination” may include cases in which, for example, judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” “Determining” may be replaced with “assuming,” “expecting,” “considering,” or the like.

The terms “connected” and “coupled” or all modifications thereof refer to all direct or indirect connecting or coupling between two or more elements, and can include a case in which one or more intermediate elements are present between the two elements “connected” or “coupled” to each other. Coupling or connecting between elements may be physical, logical, or a combination thereof. For example, “connecting” may be replaced with “accessing.” In the present disclosure, two elements can be considered to be “connected” or “coupled” to each other using at least one of one or more electrical wires, cables, and printed circuits and using electromagnetic energy or the like having wavelengths of a radio frequency area, a microwave area, and a light (both visible and invisible light) area in some non-limiting and non-inclusive examples.

The expression “based on ˜” used in the present disclosure does not mean “based on only ˜” unless otherwise described. In other words, the expression “based on ˜” means both “based on only ˜” and “based on at least ˜.”

No reference to elements named with “first,” “second,” or the like used in the present disclosure generally limit amounts or order of the elements. These naming can be used in the present disclosure as a convenient method for distinguishing two or more elements.

Accordingly, reference to first and second elements does not mean that only two elements are employed or that a first element precedes a second element in any form.

“Means” in the configuration of the aforementioned devices may be replaced with “unit,” “circuit,” “device,” or the like.

When the terms “include” and “including” and modifications thereof are used in the present disclosure, the terms are intended to have a comprehensive meaning similarly to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, the expression “A and B are different” may mean that “A and B are different from each other.” The expression may mean that “A and B are different from C.” Expressions such as “separated” and “coupled” may be construed in the same way as “different.”

### REFERENCE SIGNS LIST

1 . . . Storage battery control device
2 . . . Base station
3 . . . Storage battery
4 . . . Storage battery control system
10 . . . Control unit
11 . . . Storage unit
100 . . . Transmission/reception unit
101 . . . Selection unit
102 . . . Charging/discharging unit
103 . . . Detection unit
104 . . . Utilization unit
1001 . . . Processor
1002 . . . Memory
1003 . . . Storage
1004 . . . Communication device
1005 . . . Input device
1006 . . . Output device

1. A storage battery control device comprising processing circuitry configured to perform at least one of first control and second control when it is detected that a charging/discharging criterion for responding to a demand response (DR) request is not satisfied after one or more storage batteries have been determined as a control object of charging/discharging for responding to the DR request,
wherein the first control utilizes a storage battery other than the control object, and
wherein the second control utilizes a storage battery with a surplus charging/discharging capacity after responding to the DR request out of the storage batteries which are the control object.

2. The storage battery control device according to claim 1, wherein the second control utilizes a storage battery with a surplus charging/discharging capacity after responding to the DR request out of the storage batteries which are the control object in a period in which utilization of the storage battery is not scheduled in a period in which the DR request is responded to.

3. The storage battery control device according to claim 1, wherein the processing circuitry performs the second control with higher priority to the first control.

4. The storage battery control device according to claim 1, wherein the processing circuitry determines whether the criterion is satisfied through the second control and performs control based on a result of determination.

5. The storage battery control device according to claim 4, wherein the processing circuitry performs the second control when it is determined that the criterion is satisfied, or
wherein the processing circuitry performs the first control and the second control or performs the first control when it is determined that the criterion is not satisfied.

6. The storage battery control device according to claim 1, wherein the processing circuitry performs the first control with higher priority to the second control.

7. The storage battery control device according to claim 1, wherein the processing circuitry determines whether the criterion is satisfied through the first control and performs control based on a result of determination.

8. The storage battery control device according to claim 7, wherein the processing circuitry performs the first control when it is determined that the criterion is satisfied, or
wherein the processing circuitry performs the first control and the second control or performs the second control when it is determined that the criterion is not satisfied.

9. The storage battery control device according to claim 4, wherein the processing circuitry performs the determination based on a charging/discharging schedule of the storage batteries.

10. The storage battery control device according to claim 1, wherein the processing circuitry selects a storage battery satisfying the criterion out of all the storage batteries responding to the DR request through at least one of the first control and the second control and utilizes the selected storage battery.

11. The storage battery control device according to claim 2, wherein the processing circuitry performs the second control with higher priority to the first control.

12. The storage battery control device according to claim 2, wherein the processing circuitry performs the first control with higher priority to the second control.
